(19) United States
(12) Patent Application Publication
(10) Pub. No.: US 2018/0129057 A1
(43) Pub. Date: May 10, 2018

(54) SYSTEMS, DEVICES, AND METHODS FOR BEAM SHAPING IN A WEARABLE HEADS-UP DISPLAY

(71) Applicant: THALMIC LABS INC., Kitchener (CA)

(72) Inventors: Vance R. Morrison, Kitchener (CA); Lloyd Frederick Holland, Kitchener (CA); Ian Andrews, Kitchener (CA); Andrew S. Logan, Waterloo (CA)

(21) Appl. No.: 15/809,258

(22) Filed: Nov. 10, 2017

Related U.S. Application Data
(60) Provisional application No. 62/420,371, filed on Nov. 10, 2016.

(51) Int. Cl. G02B 27/09; G02B 26/08; G02B 5/32; G02B 27/01; G02B 27/10; G02B 26/10

(52) U.S. Cl. CPC G02B 27/0911; G02B 26/0816; G02B 5/32; G02B 27/0172; G02B 2027/0138; G02B 26/101; G02B 2027/0174; G02B 2027/0178; G02B 27/104

(57) ABSTRACT

Systems, devices, and methods for beam shaping in wearable heads-up displays (WHUD) with laser projectors are described. A WHUD includes a support structure carrying a laser projector and an eyeglass lens with a transparent combiner. The laser projector includes at least one laser diode, at least one anamorphic optical element, and a controllable mirror having a reflective area. The at least one laser diode generates laser light having a spot area with at least one dimension being smaller or larger than the dimensions of the reflective area of the controllable mirror. The at least one anamorphic optical element anamorphically reshapes the spot area such that the second spot area has approximately the same dimensions as the controllable mirror. The controllable mirror scans the reshaped laser light over the transparent combiner, which redirects the light, creating a focused image at the eye of the user with minimal loss of laser light.

### TECHNICAL FIELD

The present systems, devices, and methods generally relate to wearable heads-up displays and particularly relate to altering the beam shape of the laser light output by laser projectors in wearable heads-up displays.

### BACKGROUND

Description of the Related Art

### Laser Projectors

A projector is an optical device that projects or shines a pattern of light onto another object (e.g., onto a surface of another object, such as onto a projection screen) in order to display an image or video on that other object. A projector necessarily includes a light source, and a laser projector is a projector for which the light source comprises at least one laser. The at least one laser is temporally modulated to provide a pattern of laser light and usually at least one controllable mirror is used to spatially distribute the modulated pattern of laser light over an area of another object. The spatial distribution of the modulated pattern of laser light produces an image at or on the other object. In conventional laser projectors, the at least one controllable mirror may include: a single digital micromirror (e.g., a microelectromechanical system (“MEMS”) based digital micromirror) that is controllably rotatable or deformable in two dimensions, or two digital micromirrors that are each controllably rotatable or deformable about a respective dimension, or a digital light processing (“DLP”) chip comprising an array of digital micromirrors.

In a conventional laser projector comprising a RGB laser module with a red laser diode, a green laser diode, and a blue laser diode, each respective laser diode has a corresponding respective focusing lens. The relative positions of the laser diodes, the focusing lenses, and the at least one controllable mirror are all tuned and aligned so that each laser beam impinges on the at least one controllable mirror with substantially the same spot size and with substantially the same rate of convergence (so that all laser beams will continue to have substantially the same spot size as they propagate away from the laser projector towards, e.g., a projection screen). In a conventional laser projector, it is usually possible to come up with such a configuration for all these elements because the overall form factor of the device is not a primary design consideration. However, in applications for which the form factor of the laser projector is an important design element, it can be very challenging to find a configuration for the laser diodes, the focusing lenses, and the at least one controllable mirror that sufficiently aligns the laser beams (at least in terms of spot size, spot position, and rate of convergence) while satisfying the form factor constraints.

### Wearable Heads-Up Displays

A head-mounted display is an electronic device that is worn on a user's head and, when so worn, secures at least one electronic display within a viewable field of at least one of the user's eyes, regardless of the position or orientation of the user's head. A wearable heads-up display is a head-mounted display that enables the user to see displayed content but also does not prevent the user from being able to see their external environment. The “display” component of a wearable heads-up display is either transparent or at a periphery of the user's field of view so that it does not completely block the user from being able to see their external environment. Examples of wearable heads-up displays include: the Google Glass®, the Optinvent Ora®, the Epson Moverio®, and the Sony Glasstron®, just to name a few.

### BRIEF SUMMARY

A wearable heads-up display (“WHUD”) may be summarized as including: a support structure that in use is worn on a head of a user; a transparent combiner carried by the support structure, wherein the transparent combiner is positioned within a field of view of an eye of the user when the support structure is worn on the head of the user; a laser projector carried by the support structure, the laser projector comprising: at least one laser diode to generate laser light having a spot area; a first controllable mirror positioned to receive the laser light from the at least one laser diode and controllably orientable to redirect the laser light towards the transparent combiner, the first controllable mirror having a reflective area, the reflective area of the first controllable mirror having a respective set of dimensions; and at least one anamorphic optical element positioned in an optical path of the laser light between the at least one laser diode and the controllable mirror, wherein the at least one anamorphic optical element receives laser light having a first spot area from the at least one laser diode, and wherein the at least one anamorphic optical element is oriented to anamorphically reshape the first spot area of the laser light to provide a second spot area, the second spot area having a respective set of dimensions, the respective set of dimensions of the second spot area at least approximately matching corresponding dimensions of the respective set of dimensions of the reflective area of the first controllable mirror when the laser light impinges on the controllable mirror. The transparent combiner may include at least one holographic optical element.

The laser projector may further include: a beam combiner positioned in the optical path of the laser light in between the at least one laser diode and the controllable mirror, wherein the at least one laser diode includes a red laser diode, a green laser diode, and a blue laser diode, and wherein the beam combiner is oriented to combine red laser light from the red laser diode, green laser light from the green laser diode, and blue laser light from the blue laser diode into an aggregate laser beam. The at least one anamorphic optical element may include: a first anamorphic optical element positioned in an optical path of red laser light in between the red laser diode and the beam combiner to anamorphically reshape a respective spot area of the red laser light; a second anamorphic optical element positioned in an optical path of green laser light in between the green laser diode and the beam combiner to anamorphically reshape a respective spot area of the green laser light; and a third anamorphic optical element positioned in an optical path of blue laser light in between the blue laser diode and the beam combiner to anamorphically reshape a respective spot area of the blue laser light. The at least one anamorphic optical elements may be positioned in an optical path of the aggregate laser beam between the beam combiner and the first controllable mirror to anamorphically reshape an aggregate spot area of the aggregate laser beam.

The at least one anamorphic optical element may include at least one prism pair or at least one cylindrical lens. The first controllable mirror may be controllably orientable on two axes.

The laser projector may further include a second controllable mirror having a reflective area, the reflective area of the second controllable mirror having a respective set of dimensions, wherein: the first controllable mirror is controllably orientable on a first axis and is positioned in the optical path of the laser light between the at least one anamorphic optical element and the second controllable mirror to controllably redirect the laser light towards the second controllable mirror en route to the transparent combiner; and the second controllable mirror is controllably orientable on a second axis orthogonal to the first axis to redirect the laser light towards the transparent combiner.

The support structure of the WHUD may have a shape and appearance of an eyeglasses frame and the transparent combiner may include an eye glass lens.

A method of operating a wearable heads-up display, may be summarized as including: generating laser light having a spot area by at least one laser diode, the spot area having a first set of dimensions; shaping, by at least one anamorphic optical element, the spot area of the laser light to at least approximately match corresponding dimensions of a second set of dimensions of a reflective area of at least a first controllable mirror of the wearable heads-up display; scanning, by at least the first controllable mirror, the laser light over a transparent combiner of the wearable heads-up display, the transparent combiner positioned in a field of view of an eye of a user of the wearable heads-up display; and redirecting the laser light towards the eye of the user by the transparent combiner. The transparent combiner may include at least one holographic optical element, and scanning, by at least the first controllable mirror, the laser light over the transparent combiner of the wearable heads-up display may include scanning, by at least the first controllable mirror, the laser light over the at least one holographic optical element.

The at least one laser diode may include a red laser diode, a green laser diode, and a blue laser diode, wherein: generating laser light having a spot area by the at least one laser diode includes generating red laser light having a red spot area by the red laser diode, generating green laser light having a green spot area by the green laser diode, and generating blue laser light having a blue spot area by the blue laser diode; and wherein the method further includes: combining the red laser light, the green laser light, and the blue laser light into an aggregate laser beam by a beam combiner. The at least one anamorphic optical element may be positioned after the beam combiner in an optical path of the aggregate laser beam and shaping, by the at least one anamorphic optical element, the spot area of the laser light to at least approximately match corresponding dimensions of the second set of dimensions of the reflective area of the first controllable mirror of the wearable heads-up display may include: shaping, by the at least one anamorphic optical element, the spot area of the aggregate laser beam to at least approximately match the corresponding dimensions of the second set of dimensions of reflective area of the first controllable mirror of the wearable heads-up display. A first anamorphic optical element may be positioned in an optical path of the red laser light in between the red laser diode and the beam combiner, a second anamorphic optical element may be positioned in an optical path of the green laser light in between the green laser diode and the beam combiner, and a third anamorphic optical element may be positioned in an optical path of the blue laser light in between the blue laser diode and the beam combiner, wherein: shaping, by the at least one anamorphic optical element, the spot area of the laser light to at least approximately match corresponding dimensions of the second set of dimensions of the reflective area of the first controllable mirror of the wearable heads-up display may include: shaping, by the first anamorphic optical element, the red spot area of the red laser light to at least approximately match corresponding dimensions of the second set of dimensions of the reflective area of the first controllable mirror of the wearable heads-up display; shaping, by the second anamorphic optical element, the green spot area of the green laser light to at least approximately match corresponding dimensions of the second set of dimensions of the reflective area of the first controllable mirror of the wearable heads-up display; and shaping, by the third anamorphic optical element, the blue spot area of the blue laser light to at least approximately match corresponding dimensions of the second set of dimensions of the reflective area of the first controllable mirror of the wearable heads-up display.

The at least one anamorphic optical element may include at least one prism pair wherein: shaping, by the at least one anamorphic optical element, the spot area of the laser light to at least approximately match corresponding dimensions of the second set of dimensions of the reflective area of the first controllable mirror of the wearable heads-up display may include shaping, by the at least one prism pair, the spot area of the laser light to at least approximately match corresponding dimensions of the second set of dimensions of the reflective area of the first controllable mirror of the wearable heads-up display.

The at least one anamorphic optical element may include at least one cylindrical lens wherein: shaping, by the at least one anamorphic optical element, the spot area of the laser light to at least approximately match corresponding dimensions of the second set of dimensions of the reflective area of the first controllable mirror of the wearable heads-up display may include shaping, by the at least one cylindrical lens, the spot area of the laser light to at least approximately match corresponding dimensions of the second set of dimensions of the reflective area of the first controllable mirror of the wearable heads-up display.

The first controllable mirror may be controllably orientable on two axes.

The wearable heads-up display may include a second controllable mirror, the first controllable mirror controllably orientable on a first axis and the second controllable mirror controllably orientable on a second axis that is orthogonal to the first axis, wherein scanning, by the at least first controllable mirror, the laser light over the transparent combiner of the wearable heads-up display may include: scanning the laser light over the second controllable mirror by the first controllable mirror; and scanning the laser light over the transparent combiner by the second controllable mirror.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a schematic diagram of a wearable heads-up display with a beam-shaping laser projector, and a transparent combiner in a field of view of an eye of a user in accordance with the present systems, devices, and methods.

FIG. 2A is a schematic diagram of a reflective area of a controllable mirror with an unshaped laser beam incident thereon in accordance with present systems, devices, and methods.

FIG. 2B is a schematic diagram of a reflective area of a controllable mirror with a shaped laser beam incident thereon in accordance with present systems, devices, and methods.

FIG. 3 is a flow diagram that shows a method of operating a wearable heads-up display with a beam-shaping laser projector in accordance with present systems, devices, and methods.

FIG. 4 is an isometric view of a wearable heads-up display with a beam-shaping laser projector in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

Throughout this specification and the appended claims, the term “carries” and variants such as “carried by” or “carrying” are generally used to refer to a physical coupling between two objects. The physical coupling may be direct physical coupling (i.e., with direct physical contact between the two objects) or indirect physical coupling mediated by one or more additional objects. Thus the term carries and variants such as “carried by” are meant to generally encompass all manner of direct and indirect physical coupling.

Throughout this specification and the appended claims the term “spot area” is used. The “spot area” of a laser beam refers to the cross-sectional area of the laser beam at any point along the length of the beam. It is generally desirable for the laser beam in a laser projector to impinge on the controllable mirror with a spot area equal to the area of the controllable mirror itself. If the spot area of the laser beam at the controllable mirror is larger than the reflective area of the mirror itself then portions of the laser spot that extend over the perimeter of the mirror cannot be redirected by the mirror and may be inefficiently lost from the optical path of the projector. However, a larger spot area of the laser beam at the controllable mirror results in a smaller focused spot area of the scanned laser beam. Therefore, if the spot area of the laser beam at the controllable mirror is smaller than the reflective area of the mirror, the scanned spot area of the laser beam will be larger and less focused than desired.

The headings and Abstract of the Disclosure provided herein are for convenience only and do not interpret the scope or meaning of the embodiments. The various embodiments described herein provide systems, devices, and methods for minimizing image distortion and are particularly well-suited for use in wearable heads-up displays.

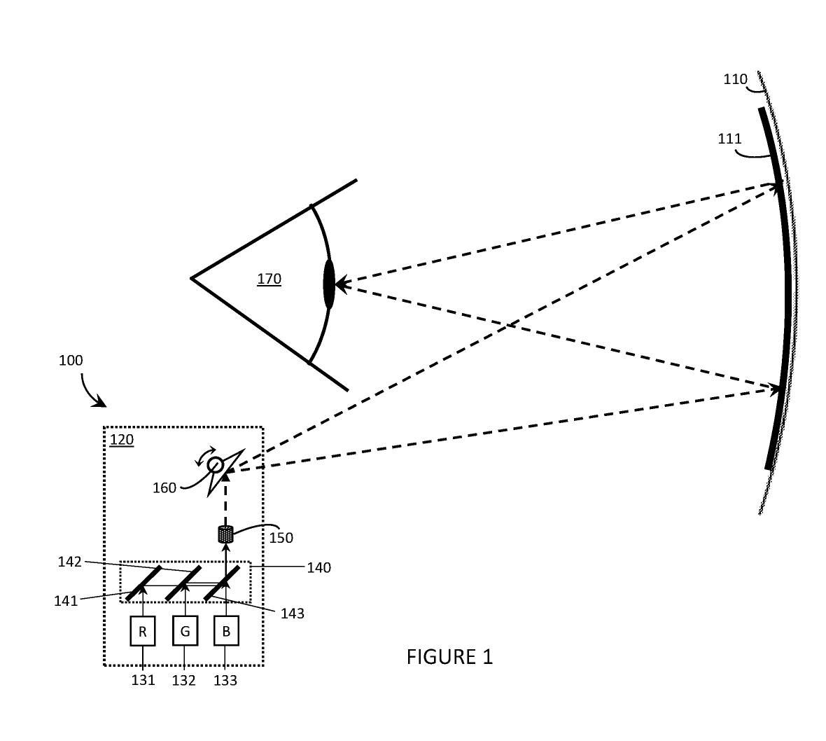

FIG. 1 is a schematic diagram of an operation of a wearable heads-up display 100 with a beam-shaping laser projector 120, and a transparent combiner 111 in a field of view of an eye 170 of a user in accordance with the present systems, devices, and methods. WHUD 100 includes a support structure, with the general shape and appearance of an eyeglasses frame, carrying an eyeglass lens 110 with a transparent combiner 111, and a laser projector 120. Laser projector 120 includes laser diodes 131, 132, and 133, a beam combiner 140 including optical elements 141, 142, and 143, an anamorphic optical element 150, and a controllable mirror 160 having a reflective area.

Exemplary wearable heads-up display 100 operates as follows. Laser diodes 131, 132, and 133 of laser projector 120 generate laser light (light shown as arrows) having a spot area. In exemplary WHUD 100, laser diode 131 is a red laser diode that generates red laser light having a red spot area, laser diode 132 is a green laser diode that generates green laser light having a green spot area, and laser diode 133 is a blue laser diode that generates blue laser light having a blue spot area. In other embodiments, the number, type, and output wavelength of light sources may be different. The output of light from the laser diodes may be modulated via signals produced by a processor (e.g., microprocessor, field programmable gate array, application specific integrated circuit, programmable logic controller or other hardware circuitry), and the processor may be communicatively coupled to a non-transitory processor-readable storage medium (e.g., volatile memory such as Random Access Memory (RAM), memory caches, processor registers; nonvolatile memory such as Read Only Memory, EEPROM, Flash memory, magnetic disks, optical disks) that stores processor-executable data and/or instructions. The red laser light, green laser light, and blue laser light are directed towards beam combiner 140. Beam combiner 140 includes three optical elements 141, 142, and 143. The red laser light is directed towards optical element 141. Optical element 141 is a mirror that reflects the red laser light towards optical element 142. The green laser light is directed towards optical element 142. Optical element 142 is a dichroic mirror that is transmissive of the red laser light and reflective of the green laser light. The red laser light and green laser light are combined by optical element 142 and directed towards optical element 143. The blue laser light is directed towards optical element 143. Optical element 142 is a dichroic mirror that is transmissive of the blue laser light and reflective of the red laser light and the green laser light. Optical element 143 combines the red laser light, green laser light, and blue laser light into an aggregate beam and directs the aggregate beam towards anamorphic optical element 150.

Laser diodes 131, 132, and 133 may generate laser light with a spot area that is smaller or larger, and different in geometric shape than the reflective area of controllable mirror 160 when incident on the controllable mirror 160. As mentioned above, a larger spot area of the laser light on the reflective area of controllable mirror 160 results in a more focused scanned laser spot area. If the spot area is smaller than the reflective area of controllable mirror 160 the resulting spot area of laser light in the image will be less focused than desired. If the spot area is larger than the reflective area of controllable mirror 160 laser light is “lost” and the generation of laser light by the laser projector is inefficient. The laser light generated by the laser diodes may have an elliptical spot wherein the width of the light on the horizontal axis may be greater than the height of the light on the vertical axis or vice versa; while controllable mirror 160 may have a circular shape. Such an elliptical laser spot area, when incident on controllable mirror 160, will result in inefficient use of the reflective area of the mirror or of the laser light. Anamorphic optical element 150 can be used to shape the laser light beam to approximately match the reflective area of controllable mirror 160. An anamorphic optical element magnifies light unequally on different axes, therefore, after light passes through the anamorphic optical element, the spot area of the light is altered in a non-uniform manner. For example, if controllable mirror 160 has a reflective area with a 1.0 mm diameter, and the laser light spot area incident on anamorphic optical element 150 was an ellipse 1.0 mm wide and 0.2 mm high, anamorphic optical element 150 may magnify the laser light on the horizontal axis by a factor of one and the laser light on the vertical axis by a factor of five to achieve an approximately circular laser light spot area 1.0 mm wide and 1.0 mm high. The laser light spot area will approximately match the reflective area of controllable mirror 160. A person of skill in the art will appreciate that the controllable mirror may not have a circular shape (at least not as seen in two dimensions from the direction from which the laser beam is incident on the controllable mirror) and that the spot area of the laser beam is shaped to optimize coverage of the mirror and minimize loss of laser light.

In FIG. 1, the aggregate beam is incident on anamorphic optical element 150 with a first spot area, and passes through anamorphic optical element 150 and is magnified unequally on its axes, resulting in a second spot area at the reflective area of controllable mirror 160 having dimensions that at least approximately match the corresponding dimensions of the reflective area of controllable mirror 160. Depending on the specific architecture of the elements of the WHUD the margin of area for approximately matching the spot area to the corresponding dimensions of the reflective area of the controllable mirror may vary. An exemplary measurement, if the controllable mirror was circular, may be that any diameter of the laser beam be within five percent of the diameter of the mirror. A person of skill in the art will appreciate that the controllable mirror as seen from the incoming direction of the incident aggregate beam may have corresponding dimensions which are not circular even when the controllable mirror itself is circular. That is, the mirror may be on an angle relative to the direction of the incoming aggregate beam such that the reflective area appears elliptical, therefore the corresponding dimensions of the reflective area of the controllable mirror are not necessarily the “actual” dimensions of the reflective area of the mirror. The aggregate beam is directed towards controllable mirror 160. The laser light output from anamorphic optical element 150 may be collimated and therefore the dimensions of the spot area that impinges on controllable mirror 160 may at least approximately match the dimensions of the spot area output by anamorphic optical element 150, or the laser light output from anamorphic element 150 may converge or diverge to impinge on controllable mirror 160 with a spot area having dimensions that at least approximately match corresponding dimensions of the reflective area of controllable mirror 160. The spot area can only approximate the reflective area of controllable mirror 160 as the reflective area of the mirror itself changes in apparent size normal to anamorphic optical element 150 as the mirror sweeps to scan the aggregate beam. Anamorphic optical element 150 may be a prism pair or a cylindrical lens. In another embodiment, a prism pair or a cylindrical lens could be present immediately after each laser diode in the optical path of the laser light instead of having one prism pair or cylindrical lens after the beam combiner in the optical path of the aggregate beam. That is, a first anamorphic optical element could be located in the path of the red laser light between red laser diode 131 and optical element 141 to shape the spot area of the red light, a second anamorphic optical element could be located in the path of the green laser light between green laser diode 132 and optical element 142 to shape the spot area of the green light, and a third anamorphic optical element could be located in the path of the blue laser light between blue laser diode 133 and optical element 143 to shape the spot area of the blue light.

Controllable mirror 160 scans the laser light onto transparent combiner 111 carried on eyeglass lens 110. Eyeglass lens 110 may be a non-prescription or prescription eyeglass lens. Transparent combiner 111 combines the environmental light with the laser light in a field of view of the user. Controllable mirror 160 may be a bi-axial mirror that directly scans the laser light onto transparent combiner 111. Alternatively, controllable mirror 160 may be a first mirror in a set of two, wherein the first mirror scans the laser light along a single axis (e.g., horizontal) towards a second mirror which scans the light on an orthogonal axis (e.g., vertical) towards transparent combiner 111. In such an implementation, the second spot area of the laser light is shaped by anamorphic optical element 150 to have approximately the same area as the reflective area of the first mirror. Transparent combiner 111 redirects the laser light towards a field of view of eye 170 of the user. Transparent combiner 111 may include at least one holographic optical element.

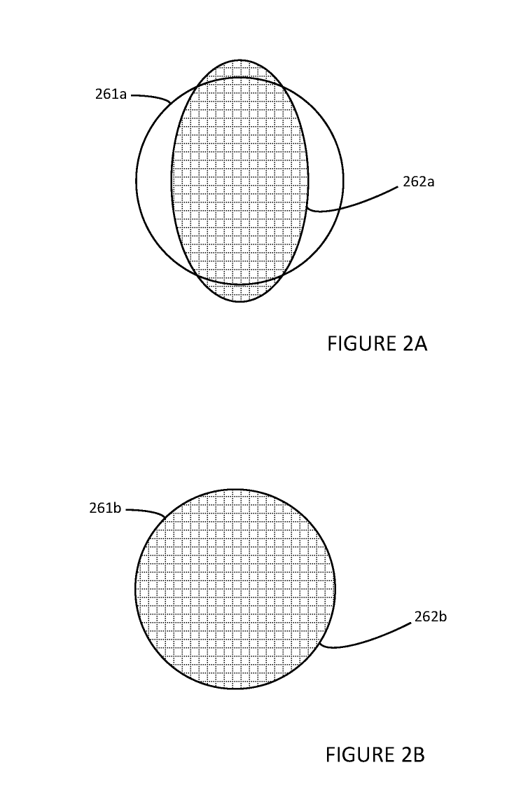

FIG. 2A is a schematic diagram of a reflective area 261a of a controllable mirror with an unshaped laser beam 262a (cross-hatched area) incident thereon within a wearable heads-up display in accordance with present systems, devices, and methods. In FIG. 2A, the wearable heads-up display requires a spot area approximately the same size and shape as reflective area 261a to create a focused image at an eye of a user, but does not include an anamorphic optical element to shape the spot area of the laser beam. The spot area of laser beam 262a incident on reflective area 261a is elliptical, with a vertical dimension larger than the diameter of reflective area 261a but a horizontal dimension that is smaller than the diameter of reflective area 261a. The focused spot area of laser light scanned by the controllable mirror would be the desired size on the vertical axis and larger on the horizontal axis, resulting in an unfocused image at an eye of a user. However, the larger vertical dimension of the spot area results in loss of laser light, shown as the extension of laser spot area 262a beyond the reflective area 261a of the controllable mirror. A person of skill in the art will appreciate that other shapes of spot area with dimensions smaller and/or larger than reflective area 261a would result in unfocused images and/or inefficient loss of laser light, respectively.

FIG. 2B is a schematic diagram of a reflective area 261b of a controllable mirror with a shaped laser beam 262b (cross-hatched area) incident thereon within a wearable heads-up display in accordance with present systems, devices, and methods. In FIG. 2B, the wearable heads-up display includes an anamorphic optical element to shape the spot area of the laser beam. Therefore, the spot area of laser beam 262b incident on reflective area 261b has been anamorphically reshaped from the elliptical spot area in FIG. 2A to a circular spot area with a diameter approximately the same as the diameter of reflective area 261b. The focused spot area of laser light scanned by the controllable mirror would be the same area on the vertical axis as on the horizontal axis, resulting in a focused image at an eye of a user.

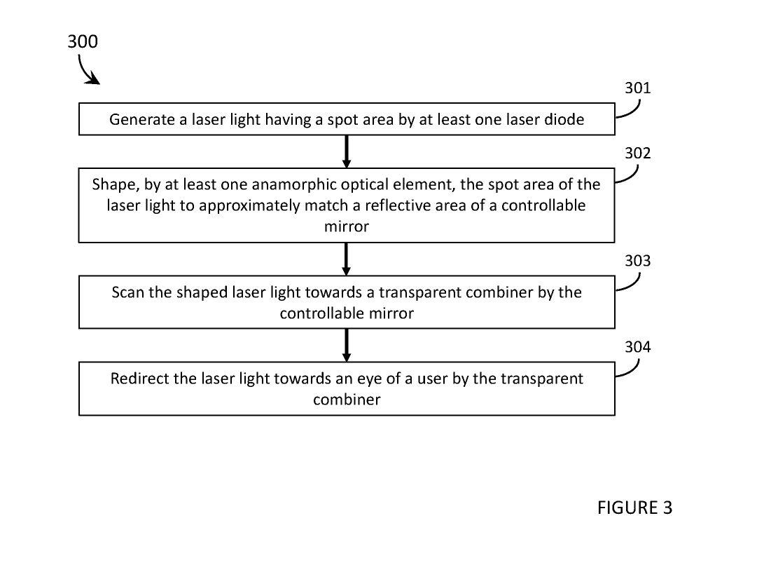

FIG. 3 shows a method 300 of operating a wearable heads-up display with a beam-shaping laser projector in accordance with the present systems, devices, and methods. The WHUD of FIG. 3 may be substantially similar to WHUD 100 of FIG. 1 and generally includes a support structure carrying: a laser projector with at least one laser diode, an anamorphic element, and a controllable mirror with a reflective area, and a transparent combiner carried on an eyeglass lens. Method 300 includes acts 301, 302, 303, and 304, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 301, the at least one laser diode generates a laser light having a spot area that when incident on the controllable mirror would result in an inefficient loss of laser light or an unfocused image at an eye of a user, unless the laser light is reshaped. The laser diode may be communicatively coupled to a processor which modulates the generation of laser light by the at least one laser diode via control signals. The at least one laser diode may include a red laser diode to generate red laser light having a red laser spot area, a green laser diode to generate green laser light having a green laser spot area, and a blue laser diode to generate blue laser light having a blue laser spot area, wherein the laser projector also includes a beam combiner to combine the red laser light, green laser light, and blue laser light into an aggregate beam.

At 302, the spot area of the laser light is anamorphically shaped to a second spot area with dimensions that approximately match corresponding dimensions of a reflective area of a controllable mirror, by at least one anamorphic optical element. The at least one anamorphic optical element magnifies the laser light unequally on different axes as discussed above to achieve a spot area with dimensions that approximately match corresponding dimensions of the reflective area of the controllable mirror. The resulting laser light spot area creates a focused image. In an embodiment where the laser projector includes a red laser diode generating red laser light having a red spot area, a green laser diode generating green laser light having a green spot area, a blue laser diode generating blue laser light having a blue spot area) and a beam combiner to combine the laser light into an aggregate beam, the at least one anamorphic optical element may be a single anamorphic optical element located in the path of the aggregate beam after the beam combiner and before the controllable mirror. Alternatively, the at least one anamorphic element may include a first anamorphic optical element located in the path of the laser light between a the red laser diode and the beam combiner to shape the red laser spot area, a second anamorphic optical element in the path of the laser light between the green laser diode and the beam combiner to shape the green laser spot area, and a third anamorphic optical element in the path of the laser light between the blue laser diode and the beam combiner to shape the blue laser spot area. In any implementation, the at least one anamorphic optical element may be at least one prism pair or at least one cylindrical lens.

At 303, the shaped laser light is scanned towards the transparent combiner by the controllable mirror. The controllable mirror may be a bi-axial mirror that directly scans the laser light onto the transparent combiner. Alternatively, the controllable mirror may be a first mirror in a set of two mirrors, wherein the first mirror scans the laser light along a single axis (e.g., horizontal axis) towards a second mirror which scans the light on an orthogonal axis (e.g., vertical axis) towards the transparent combiner. In such an embodiment, the spot area of the laser light is shaped to have approximately the same dimensions as the corresponding dimensions of the reflective area of the first mirror.

At 304, the shaped laser light is directed towards a field of view of the eye of the user by the transparent combiner. The transparent combiner may include at least one holographic optical element. The transparent combiner directs the light to an exit pupil at the eye of the user. The reshaped spot area of the laser light will result in a focused image at a retina of the eye of the user.

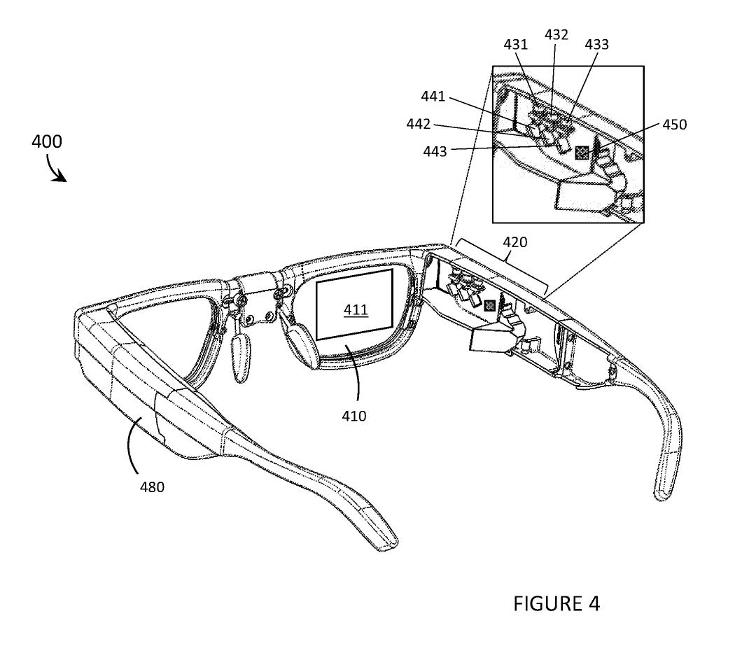

FIG. 4 is an isometric view of a wearable heads-up display 400 with a beam-shaping laser projector 420 in accordance with the present systems, devices, and methods. WHUD 400 includes a support structure 480 that in use is worn on the head of the user and has a general shape and appearance of an eyeglasses frame. Support structure 480 carries multiple components, including an eyeglass lens 410, a transparent combiner 411, and a laser projector 420. Laser projector 420 includes (blow-out) laser diodes 431, 432, and 433, a beam combiner, an anamorphic optical element 450, and a controllable mirror having a reflective area (not shown). The beam combiner includes optical elements 441, 442, and 443. WHUD 400 operates in generally the same manner as WHUD 100 from FIG. 1.

Laser diodes 431, 432, and 433 generate laser light having a spot area. As in FIG. 1, red laser diode 431 generates red laser light having a red spot area, green laser diode 432 generates green laser light having a green spot area, and blue laser diode 433 generates blue laser light having a blue spot area. The red laser light is directed towards optical element 441, a mirror, which reflects the red laser light towards optical element 442. The green laser light is directed towards optical element 442. Optical element 442 is a dichroic mirror that is transmissive to the red laser light and reflective to the green laser light and directs combined red and green light towards optical element 443. The blue laser light is directed towards optical element 443. Optical element 443 is a dichroic mirror which is reflective to the red laser light and green laser light and transmissive to the blue laser light. Optical element 443 combines the red laser light, green laser light, and blue laser light into an aggregate beam and directs the aggregate beam towards anamorphic optical element 450. Anamorphic optical element 450 receives the aggregate beam and applies a magnification to the aggregate beam that is unequal on different axes. Anamorphic optical element 450 is positioned, oriented, and shaped to anamorphically reshape the spot area of the beam to approximately the same dimensions as a reflective area of a controllable mirror. Anamorphic optical element 450 may be at least one prism pair or at least one cylindrical lens. The aggregate beam is then directed toward transparent combiner 411 by the controllable mirror (not shown in FIG. 4). The controllable mirror may be a single bi-axial scan mirror or the controllable mirror may be a first mirror in a set of two, wherein the first mirror scans the laser light along a single axis (e.g. horizontal) towards a second mirror which scans the light on an orthogonal axis (e.g. vertical) towards the transparent combiner. In such an embodiment, the second spot area of the laser light is shaped to have approximately the same dimensions as the reflective area of the first mirror. The aggregate beam is directed towards a field of view of an eye of a user by the transparent combiner. The transparent combiner may include at least one holographic optical element.

A person of skill in the art will appreciate that additional optics which affect the laser light may be positioned in the optical path between the at least one anamorphic optical element and the controllable mirror. Therefore, the at least one anamorphic optical element may initially provide a spot area which compensates for the optical effects of these additional optics in order to achieve the desired second spot area at the controllable mirror. Additional optics may, at least, include: apertures, optical filters, beam splitters, mirrors, reflectors, prisms, gratings, refractors, dichroic mirrors, and, or lenses, e.g., collimating lenses, converging lenses, and/or diverging lenses, cylindrical lenses.

A person of skill in the art will appreciate that the various embodiments for minimizing image distortion described herein may be applied in non-WHUD applications. For example, the present systems, devices, and methods may be applied in non-wearable heads-up displays and/or in other applications that may or may not include a visible display.

In some implementations, one or more optical fiber(s) may be used to guide light signals along some of the paths illustrated herein.

The WHUDs described herein may include one or more sensor(s) (e.g., microphone, camera, thermometer, compass, altimeter, and/or others) for collecting data from the user's environment. For example, one or more camera(s) may be used to provide feedback to the processor of the WHUD and influence where on the display(s) any given image should be displayed.

The WHUDs described herein may include one or more on-board power sources (e.g., one or more battery(ies)), a wireless transceiver for sending/receiving wireless communications, and/or a tethered connector port for coupling to a computer and/or charging the one or more on-board power source(s).

The WHUDs described herein may receive and respond to commands from the user in one or more of a variety of ways, including without limitation: voice commands through a microphone; touch commands through buttons, switches, or a touch sensitive surface; and/or gesture-based commands through gesture detection systems as described in, for example, U.S. Non-Provisional patent application Ser. No. 14/155,087, U.S. Non-Provisional patent application Ser. No. 14/155,107, PCT Patent Application PCT/US2014/057029, and/or U.S. Provisional Patent Application Ser. No. 62/236,060, all of which are incorporated by reference herein in their entirety.

Throughout this specification and the appended claims, the term “processor” is often used. Generally, “processor” refers to hardware circuitry, in particular any of microprocessors, microcontrollers, application specific integrated circuits (ASICs), digital signal processors (DSPs), programmable gate arrays (PGAs), and/or programmable logic controllers (PLCs), or any other integrated or non-integrated circuit that perform logic operations.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to: US Patent Application Publication No. US 2015-0378161 A1, U.S. Non-Provisional patent application Ser. No. 15/046,234, U.S. Non-Provisional patent application Ser. No. 15/046,254, US Patent Application Publication No. US 2016-0238845 A1, U.S. Non-Provisional patent application Ser. No. 15/145,576, U.S. Non-Provisional patent application Ser. No. 15/145,609, U.S. Non-Provisional patent application Ser. No. 15/145,583, U.S. Non-Provisional patent application Ser. No. 15/256,148, U.S. Non-Provisional patent application Ser. No. 15/167,458, U.S. Non-Provisional patent application Ser. No. 15/167,472, U.S. Non-Provisional patent application Ser. No. 15/167,484, U.S. Provisional Patent Application Ser. No. 62/271,135, U.S. Non-Provisional patent application Ser. No. 15/331,204, US Patent Application Publication No. US 2014-0198034 A1, US Patent Application Publication No. US 2014-0198035 A1, U.S. Non-Provisional patent application Ser. No. 15/282,535, U.S. Provisional Patent Application Ser. No. 62/268,892, U.S. Provisional Patent Application Ser. No. 62/322,128, U.S. Provisional Patent Application Ser. No. 62/420,368, U.S. Provisional Patent Application Ser. No. 62/420,371 and U.S. Provisional Patent Application Ser. No. 62/420,380, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable heads-up display (“WHUD”) comprising:
a support structure that in use is worn on a head of a user;
a transparent combiner carried by the support structure, wherein the transparent combiner is positioned within a field of view of an eye of the user when the support structure is worn on the head of the user;
a laser projector carried by the support structure, the laser projector comprising:
at least one laser diode to generate laser light having a spot area;
a first controllable mirror positioned to receive the laser light from the at least one laser diode and controllably orientable to redirect the laser light towards the transparent combiner, the first controllable mirror having a reflective area, the reflective area of the first controllable mirror having a respective set of dimensions; and
at least one anamorphic optical element positioned in an optical path of the laser light between the at least one laser diode and the controllable mirror, wherein the at least one anamorphic optical element receives laser light having a first spot area from the at least one laser diode, and wherein the at least one anamorphic optical element is oriented to anamorphically reshape the first spot area of the laser light to provide a second spot area, the second spot area having a respective set of dimensions, the respective set of dimensions of the second spot area at least approximately matching corresponding dimensions of the respective set of dimensions of the reflective area of the first controllable mirror when the laser light impinges on the controllable mirror.

2. The WHUD of claim 1 wherein the transparent combiner includes at least one holographic optical element.

3. The WHUD of claim 1 wherein the laser projector further comprises:
a beam combiner positioned in the optical path of the laser light in between the at least one laser diode and the controllable mirror, wherein the at least one laser diode includes a red laser diode, a green laser diode, and a blue laser diode, and wherein the beam combiner is oriented to combine red laser light from the red laser diode, green laser light from the green laser diode, and blue laser light from the blue laser diode into an aggregate laser beam.

4. The WHUD of claim 3 wherein the at least one anamorphic optical element includes:
a first anamorphic optical element positioned in an optical path of red laser light in between the red laser diode and the beam combiner to anamorphically reshape a respective spot area of the red laser light;
a second anamorphic optical element positioned in an optical path of green laser light in between the green laser diode and the beam combiner to anamorphically reshape a respective spot area of the green laser light; and
a third anamorphic optical element positioned in an optical path of blue laser light in between the blue laser diode and the beam combiner to anamorphically reshape a respective spot area of the blue laser light.

5. The WHUD of claim 3 wherein the at least one anamorphic optical element is positioned in an optical path of the aggregate laser beam between the beam combiner and the first controllable mirror to anamorphically reshape an aggregate spot area of the aggregate laser beam.

6. The WHUD of claim 1 wherein the at least one anamorphic optical element includes at least one prism pair.

7. The WHUD of claim 1 wherein the at least one anamorphic optical element includes at least one cylindrical lens.

8. The WHUD of claim 1 wherein the first controllable mirror is controllably orientable on two axes.

9. The WHUD of claim 1 wherein the laser projector further comprises a second controllable mirror having a reflective area, the reflective area of the second controllable mirror having a respective set of dimensions, and wherein:
the first controllable mirror is controllably orientable on a first axis and is positioned in the optical path of the laser light between the at least one anamorphic optical element and the second controllable mirror to controllably redirect the laser light towards the second controllable mirror en route to the transparent combiner; and
the second controllable mirror is controllably orientable on a second axis orthogonal to the first axis to redirect the laser light towards the transparent combiner.

10. The WHUD of claim 1 wherein the transparent combiner includes an eyeglass lens.

11. The WHUD of claim 1 wherein the support structure has a shape and appearance of an eyeglasses frame.
